(19) United States
(12) Patent Application Publication
(10) Pub. No.: US 2016/0101513 A1
(43) Pub. Date: Apr. 14, 2016

(54) FOREARM REST FOR PORTABLE SAW

(71) Applicant: James A. Rogers, Redondo Beach, CA (US)

(72) Inventor: James A. Rogers, Redondo Beach, CA (US)

(21) Appl. No.: 14/512,689

(22) Filed: Oct. 13, 2014

(51) Int. Cl. B25F 5/02; B27B 9/00

(52) U.S. Cl. CPC B25F 5/026; B27B 9/00

(57) ABSTRACT

A forearm rest for a hand-controlled saw which comprises a padded arm rest attached to a pair of adjustable arm rails. A pair of extension rails couple the padded arm rest and adjustable arm rails to the saw. The forearm rest can be adjusted to conform to the size of a user's forearm.

### BACKGROUND OF THE INVENTION

1. Field of the Invention

The present invention provides a hand-controlled saw having a forearm rest attached to the rear of the saw.

2. Description of the Prior Art

Hand-controlled, or portable, circular and chain saws are well known and have been available for many years.

A typical portable hand-controlled circular saw, such as those shown in U.S. Pat. No. 7,059,228 to Chang, are of a weight (typical ten pounds) such that continuous use of these types of saws over a period of time can increase fatigue, reduce saw control and, as a result, compromise on safety.

What is thus desired is to provide a saw attachment which substantially eliminates the problems noted hereinabove.

### SUMMARY OF THE INVENTION

The present invention provides an extension that can be attached to a conventional hand-controlled saw behind the operating trigger in a manner that improves saw control by the added leverage provided by the extension by its position relative to the saw rear handle. The extension connects to the saw in a manner dependent upon the type of saw being used and has a forearm pad that is adjustable.

### DESCRIPTION OF THE DRAWINGS

For a better understanding of the present invention as well as other objects and further features thereof, reference is made to the following description which is to be read in conjunction with the accompanying drawing therein:

FIG. 1 is a perspective view showing the forearm rest of the present invention coupled to a circular saw;

FIGS. 2A-2C illustrate the components that form the forearm rest of the present invention; and

FIG. 3 illustrates the assembled forearm rest of the present invention.

### DESCRIPTION OF THE INVENTION

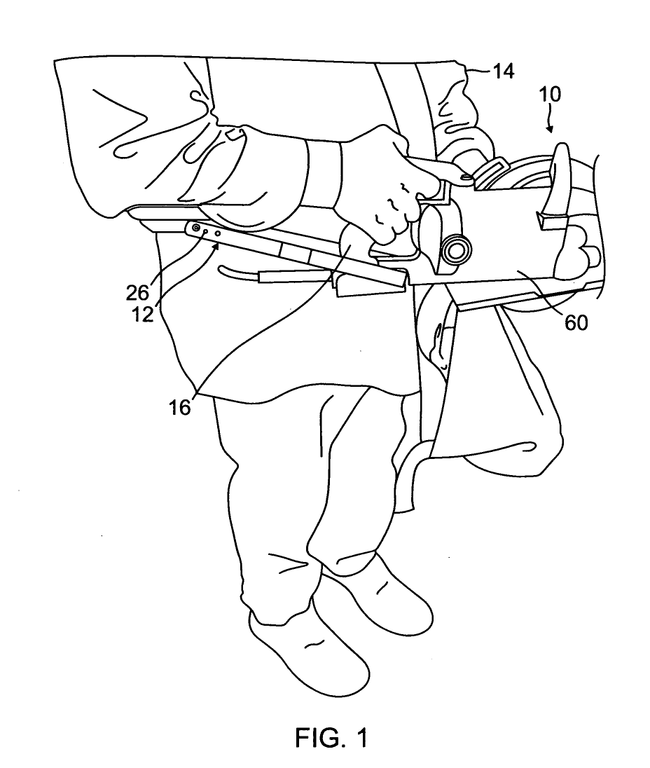

FIG. 1 is a perspective view of a hand-controlled saw 10 using the handle extension, or forearm rest, 12 of the present invention. Although a circular saw is illustrated, the invention can be used with other hand held saws, such as a chain saw.

A user 14 is shown gripping the trigger (not shown) mounted within handle 16 of saw 10. It should be noted that saw 10 does not form a part of the present invention.

Forearm rest 12 is formed of any material strong enough to support the weight of saw 10, such as metal, and functions to add leverage to compensate for the weight of saw 10.

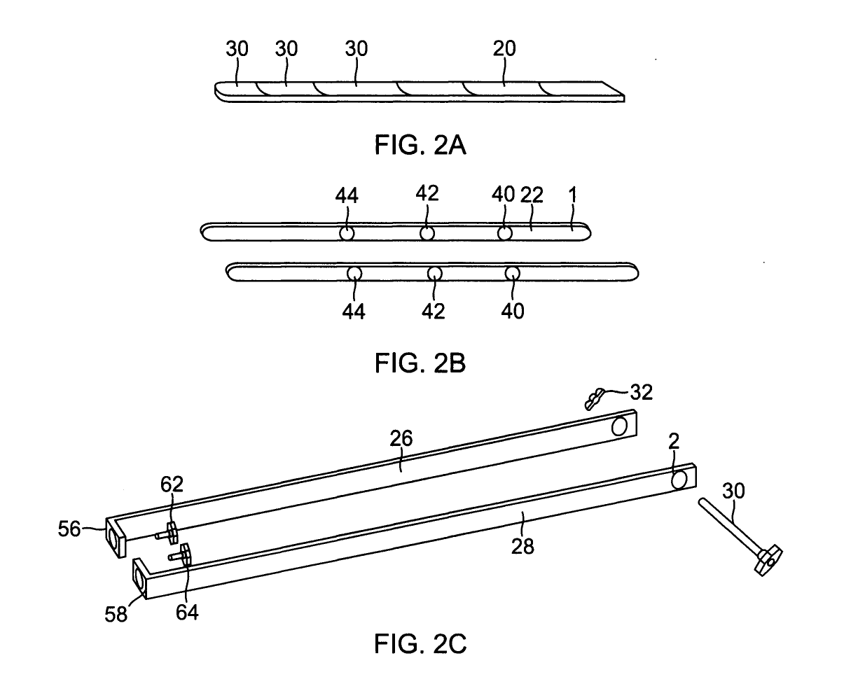

FIGS. 2A-2C show forearm rest 12 in more detail and comprises, padded arm rest 20, pivotable adjustable arm rails 22, 24 and housing extension rails 26, 28. The arm rest 20 comprises a series of foam rubber pads 30 secured together by an adhesive, such as glue, and is attached to the bottom of arm rails 22, 24 and parallel to each rail side by spot welds. It should be noted that the arm rails and the adjustable extension rails may be formed as an integral piece. The adjustable arm rails 22, 24 with the padded arm rest 20 attached thereto is, in turn, attached to housing extension rails 26, 28 via bolt 30 and nut 32. Arm rails 22 and 24 pivot because single bolt 30 connects them to the extension rails; when only a single point of connection exists from a horizontally longer piece to a shorter vertical piece, a pivot point about the loosely secured bolt 30 results. Bolt 30 is inserted into one of the aperture, or opening, pairs, 40, 42 or 44, allowing the forearm rest 12 to be adjusted to a length compatible with the forearm size of user 14. Rails 26 and 28 have flange portions 56, 58, respectively, each flange having an aperture formed therein. Forearm rest 12 is connected, in one version, to saw housing 60 behind the operating trigger using threaded bolts 62, 64 inserted through the corresponding apertures, or openings, formed in the flange portions 56, 58 in rails 26, 28. The forearm rest 12 can be connected to the saw in alternate ways; for example forearm rest 12 can be connected to handle 16. As noted above, forearm rest 12 can be adjusted in length to correspond to the forearm dimensions of user 14.

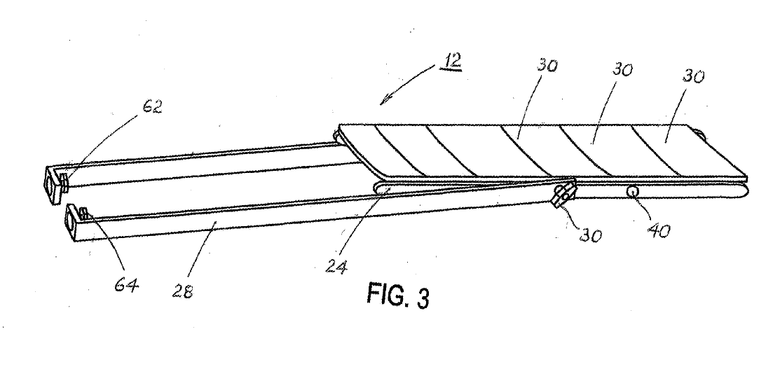

FIG. 3 shows forearm rest 12 assembled for attachment to saw 10.

The forearm rest 12 preferably is made of plastic using injection molding. In this case, the housing extension rails are joined and molded as one piece with a connecting bar therebetween. The arm rails and the padded arm rest are molded together as one piece.

The forearm rest 12 of the present invention thus provides a simple and cost effective device for allowing users to hold a saw for long periods of time without the arm fatigue which typically arises when conventional heavy hand controlled saws are used.

While the invention has been described with reference to its preferred embodiments, it will be understood by those skilled in the art that various changes may be made and equivalents may be substituted for elements thereof without departing from the true spirit and scope of the invention. In addition, many modifications may be made to adapt a particular situation or material to the teachings of the invention without departing from its essential teachings.

What is claimed is:

1. A forearm rest for use with a hand-controlled saw comprising:
a padded arm rest having first and second edges extending in a longitudinal direction;
first and second spaced apart arm rails, said padded arm rest being attached to said first and second arm rails, respectively;
first and second spaced apart extension rails, said first and second extension rails being secured to said first and second arm rails, respectively; and
means for attaching said first and second extension rails to said saw.

2. The forearm rest of claim 1 wherein a first set of apertures are formed in said first arm rail and a second set of apertures are formed in said second arm rail, said first set of apertures being aligned with said second set of apertures.

3. The forearm rest of claim 2 wherein said first and second extension rails each have an aperture, said rail apertures being aligned with each other.

4. The forearm rest of claim 3 wherein a fastener is inserted through said first aperture in said first extension rail, through a set of aligned apertures in said arm rails and through said second aperture in said second extension rail.
